(19) United States
(12) Patent Application Publication
(10) Pub. No.: US 2025/0223187 A1
(43) Pub. Date: Jul. 10, 2025

(54) PREPARATION OF METAL OXIDE NANOPARTICLES FROM CATHODES OF LITHIUM-ION BATTERIES

(71) Applicant: Saudi Arabian Oil Company, Dhahran (SA)

(72) Inventors: Madina Baltaeva, Moscow (RU); Anton Manakhov, Ivanovo (RU); Nikita Akhmetov, Novosibirsk (RU); Abdulaziz S. Al-Qasim, Dammam (SA)

(21) Appl. No.: 18/407,947

(22) Filed: Jan. 9, 2024

(51) Int. Cl. C01G 45/02; C01G 51/04; C01G 53/04; C09D 11/037; C09K 8/03; C09K 8/58

(52) U.S. Cl. CPC C01G 45/02; C01G 51/04; C01G 53/04; C09D 11/037; C09K 8/032; C09K 8/58; C01P 2004/61; C01P 2004/62; C01P 2004/64; C09K 2208/10

(57) ABSTRACT

The disclosure relates to methods to prepare metal oxide nanoparticles (MONs) from the cathodes of lithium-ion batteries (LIBs) and carbon dioxide, and related compositions and systems. Carbon dioxide is converted into oxalate or oxalic acid via a direct electrochemical process or via conversion of formate as an intermediate. The oxalate or oxalic acid formed is then used to separate transition metals from the cathode of the lithium-on batteries and the metals are used to form MONs.

### FIELD

The disclosure relates to methods to prepare metal oxide nanoparticles (MONs) from the cathodes of lithium-ion batteries (LIBs) and carbon dioxide, and related compositions and systems. Carbon dioxide is converted into oxalate or oxalic acid via a direct electrochemical process or via conversion of formate as an intermediate. The oxalate or oxalic acid formed is then used to separate transition metals from the cathode of the lithium-on batteries and the metals are used to form MONs.

### BACKGROUND

Methods to recycle the cathodes of LIBs allow for the use of metals in the cathodes of LIBs. Certain methods to recycle the cathodes of LIBs methods can have relatively high energy consumption and/or cause ecological concerns.

### SUMMARY

The disclosure relates to methods to prepare metal oxide nanoparticles (MONs) from the cathodes of lithium-ion batteries (LIBs) and carbon dioxide, and related compositions and systems. Carbon dioxide is converted into oxalate or oxalic acid via a direct electrochemical process or via conversion of formate as an intermediate. The oxalate or oxalic acid formed is then used to separate transition metals from the cathode of the lithium-on batteries and the metals are used to form MONs.

The methods can allow for the use of spent cathodes of LIBs and can be relatively robust, inexpensive, and/or environmentally friendly relative to certain other methods for processing spent cathodes of LIBs. The methods can be more energy efficiency and/or use milder conditions, such as relatively low temperatures and non-toxic chemicals, to process the spent cathodes of LIBs, relative to certain other methods to process spent cathodes of LIBs. The methods can provide higher recovery of metals from spent cathodes of LIBs relative to certain other methods for processing spent cathodes of LIBs. Additionally, the MONs can be less expensive to prepare relative to certain other nanoparticles.

The MONs prepared by the methods of the disclosure can be used to improve the properties in drilling fluids, inks, and/or a fluid for enhanced oil recovery.

In a first aspect, the disclosure provides a method, including: converting carbon dioxide into oxalic acid; dissolving a cathode material including a metal using a leaching solution including an acidic agent and a reducing agent to provide a first solution including ions of the metal; adding a second solution including a member selected from the group consisting of oxalic acid and an oxalate salt to the first solution to precipitate a metal oxalate; and calcining the metal oxalate to form metal oxide nanoparticles.

In some embodiments, the method further includes, prior to converting the carbon dioxide, capturing the carbon dioxide from a source, and using the captured carbon dioxide in the conversion of carbon dioxide into oxalic acid.

In some embodiments, calcining the metal oxalate produces carbon dioxide, and the carbon dioxide produced by calcining the metal oxalate is captured.

In some embodiments, converting the carbon dioxide into oxalic acid includes direct electrochemical conversion of carbon dioxide into oxalic acid.

In some embodiments, converting the carbon dioxide into oxalic acid includes converting carbon dioxide into formate, and converting the formate into oxalic acid.

In some embodiments, the leaching solution includes from 0.5 M to 2 M of the acidic agent and from 2 vol. % to 10 vol. % of the reducing agent.

In some embodiments, the acidic agent includes a member selected from the group consisting of sulfuric acid, citric acid, tartaric acid, acetic acid, glycolic acid, maleic acid, succinic acid, acrylic acid, lactic acid, benzoic acid, and propionic acid. In some embodiments, the reducing agent includes a member selected from the group consisting of hydrogen peroxide, sodium bisulfite, ascorbic acid, and citric acid.

In some embodiments, dissolving the cathode material is performed at a temperature of from 60° C. to 80° C.

In some embodiments, the calcining is performed at a temperature of from 250° C. to 450° C.

In some embodiments, the calcining is performed for from 1 hour to 4 hours.

In some embodiments, the metal oxide nanoparticles include at least one member selected from the group consisting of nickel oxide, manganese oxide and cobalt oxide.

In some embodiments, the metal oxide nanoparticles include from 0 to 99 wt. % nickel oxide, from 0 to 99 wt. % manganese oxide, and/or from 0 to 99 wt. % cobalt oxide.

In some embodiments, the metal oxide nanoparticles have a size of from 10 nm to 10000 nm.

In some embodiments, the method further includes, prior to adding the second solution, adjusting a pH of the first solution to from 2 to 7.

In some embodiments, the method further includes, prior to dissolving the cathode material, isolating the cathode material from at least one other component of a lithium-ion battery, including contacting the cathode material with a solvent.

In some embodiments, contacting the cathode material with a solvent is performed at a temperature of from 65° C. to 90° C.

In some embodiments, the method further includes, prior to isolating the cathode material from at least one other component of a lithium-ion battery, dismantling a lithium-ion battery cell or bundle.

In some embodiments, the method further includes, prior to dismantling the lithium-ion battery cell or bundle, discharging the lithium-ion battery cell or bundle, including immersing the lithium-ion battery cell or bundle in an alkali solution.

In some embodiments, the alkali solution has a concentration of an alkali agent of 5 wt. % to 15 wt. %.

In some embodiments, the method further includes, forming a member selected from the group consisting of a drilling fluid, an ink and a fluid used in an enhanced oil recovery operation, wherein the member includes the metal oxide nanoparticles.

### BRIEF DESCRIPTION OF THE FIGURES

FIG. 1 depicts a flowchart for a method.

FIG. 2 depicts a flowchart for a method.

FIG. 3 depicts a flowchart for a method.

### DETAILED DESCRIPTION

### Methods to Form Metal Oxide Nanoparticles

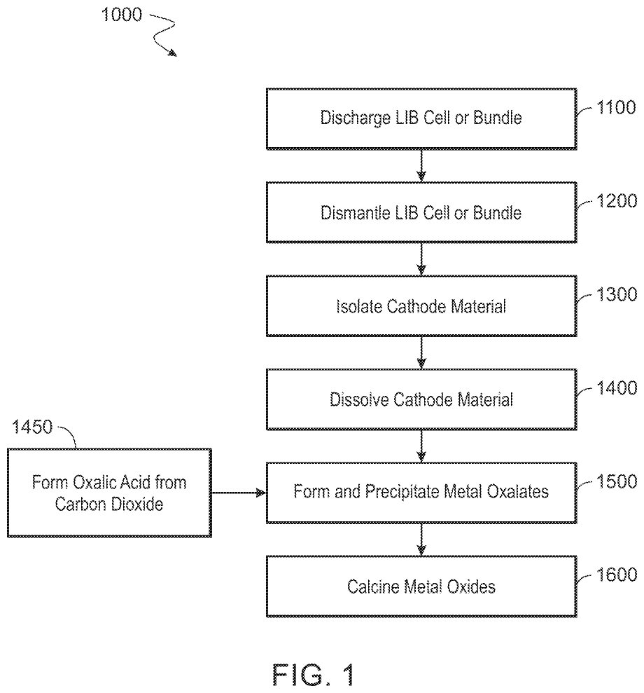

FIG. 1 depicts a flowchart for a method 1000 of forming MONs from the cathode of LIBs and carbon dioxide. In general, the cathodes can include LiNiO₂, LiMnO₂, LiCoO₂, and/or LiNiₓMn_{y}CO_{z}O₂.

In step 1100 a LIB cell or bundle is discharged. In general, the discharging can be performed by any appropriate method, such as immersion into an alkali solution. The alkali agent can include any appropriate alkali agent, such as, for example, K₂CO₃, Na₂CO₃, and/or NH₄HCO₃. In some embodiments, the alkali solution has a concentration of the alkali agent of at least 5 (e.g., at least 6, at least 7, at least 8, at least 9, at least 10, at least 11, at least 12, at least 13, at least 14) wt. % and/or at most 15 (e.g., at most 14, at most 13, at most 12, at most 11, at most 10, at most 9, at most 8, at most 7, at most 6) wt. %. In some embodiments, the alkali solution has a pH of at least 8 (e.g., at least 9, at least 10, at least 11, at least 12, at least 13) and/or at most 14 (e.g., at most 13, at most 12, at most 11, at most 10, at most 9). In some embodiments, the LIB cell or bundle is immersed in the alkali solution for at least 12 (e.g., at least 18, at least 24, at least 30, at least 36, at least 42) hours and/or at most 48 (e.g., at most 42, at most 36, at most 30, at most 24, at most 18) hours. Without wishing to be bound by theory, it is believed that in general the temperature does not significantly impact the discharging.

In general, the discharging is performed to suppress the voltage of the LIB cell or bundle to a voltage sufficiently low to allow for safe dismantling of the LIB cell or bundle. In some embodiments, the LIB cell's voltage is 3.5-4.0 V prior to the discharging and/or 1.0-2.0 V after the discharging.

In step 1200, the LIB cell or bundle is dismantled. The dismantling can include removing stainless-steel battery cases and unwinding the cathode from the rod which it is wound around. The dismantling can be performed immediately after removal from the alkali solution in the step 1100. Generally, the cathode (e.g., in the form of a tape) is washed with a solvent, such as a C₁₋₃ alcohol (e.g., ethanol, isopropanol), dried and cut into pieces. In certain embodiments, the drying is performed at a temperature of at least 65 (e.g., 70, at least 75, at least 80° C.) and/or at most 85 (e.g., at most 80, at most 75, at most 70° C.) In certain embodiments, the cathode (e.g., the cathode tape) is cut into pieces with a size of at least 1 cm² and/or at most 10 cm². In certain embodiments, the cathode (e.g., the cathode tape) is cut into pieces with a size of at least 1 (e.g., at least 2, at least 3, at least 4, at least 5, at least 6, at least 7, at least 8, at least 9) cm² and/or at most 10 (e.g., at most 9, at most 8, at most 7, at most 6, at most 5, at most 4, at most 3, at most 2) cm². In certain embodiments, the cathode (e.g., the cathode tape) is cut into 2 cm² pieces. Without wishing to be bound by theory, it is believed that cutting the cathode into pieces can make the method 1000 easier to perform.

Dismantling in step 1200 can also include addressing other components in the LIB cell or bundle. For example, step 1200 can include immersing an anode and/or separator into an alkali solution to neutralize fluorine-containing anions present in the liquid electrolyte of the dismantled battery cells.

In step 1300, the cathode separated in the step 1200 from other cell components is further processed to isolate the cathode active material from other components of the cathode, such as polymeric binder and conductive carbon additive. This can includes contacting the cut cathode with a solvent, such as DMF, DMSO, or NMP, to remove the polymeric binder and to simultaneously detach the cathode active material from the aluminum substrate. The cut cathode and solvent are mixed under relatively mild conditions and the obtained product is filtered, washed, and dried (e.g., using a vacuum oven). In some embodiments, the battery cell includes at least 20 (e.g., at least 25, at least 30, at least 35) wt. % and/or at most 40 (e.g., at most 35, at most 30, at most 25) wt. % cathode material. Without wishing to be bound by theory, it is believed that from one LIB cell, it is possible to obtain 5 to 20 g of cathode material.

In certain embodiments the amount of solvent relative to the amount of cathode material in the step 1300 is at least 3 (e.g., at most 4, at most 5, at most 6, at most 7, at most 8, at most 9) mL/g and/or at most 10 (e.g., at most 9, at most 8, at most 7, at most 6, at most 5, at most 4) mL/g.

In some embodiments, the mixing is performed at a temperature of at least 65 (e.g., at least 70, at least 75, at least 80, at least 85)° C. and/or at most 90 (e.g., at most 85, at most 80, at most 75, at most 70° C.) In some embodiments, the mixing is performed for at least 2 (e.g., at least 3, at least 4, at least 5, at least 6, at least 7) hours and/or at most 8 (e.g., at most 7, at most 6, at most 5, at most 4, at most 3) hours.

In certain embodiments, the washing is performed with a C₁₋₃ solvent, such as ethanol or isopropanol. In certain embodiments, the drying is performed for at least 1 (e.g., at least 2, at least 4, at least 6, at least 8, at least 10, at least 12, at least 14, at least 16, at least 18, at least 20, at least 22, at least 24, at least 26, at least 28, at least 30, at least 32, at least 34) hours and/or at most 36 (e.g., at most 34, at most 32, at most 30, at most 24, at most 18, at most 16, at most 14, at most 12, at most 10, at most 8, at most 6, at most 4, at most 2) hours. In some embodiments, the drying is performed at a temperature of at least 25 (e.g., at least 30, at least 35, at least 40, at least 45, at least 50, at least 55, at least 60, at least 65, at least 70, at least 75, at least 80, at least 85° C.) and/or at most 90 (e.g., at most 85, at most 80, at most 75, at most 70, at most 65, at most 60, at most 55, at most 50, at most 45, at most 40, at most 35, at most 30° C.) In some embodiments, the drying is performed at a pressure of at least 1 (e.g., at least 2, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) mBar and/or at most 100 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 5, at most 2) mBar. In some embodiments, the drying is performed under vacuum.

In step 1400, the cathode material is dissolved using a leaching solution including an acidic agent and a reducing agent to dissolve the cathode material and convert metals present in the cathode materials into ionic form in solution. The metals present in the cathode material can include lithium, nickel, manganese, and/or cobalt. The dissolution is carried out under intensive stirring. After the dissolution the carbon residue (typically 1-10 wt. %) is filtered out.

In some embodiments, the leaching solution includes at least 0.5 (e.g., at least 0.6, at least 0.7, at least 0.8, at least 0.9, at least 1.0, at least 1.1, at least 1.2, at least 1.3, at least 1.4, at least 1.5, at least 1.6, at least 1.7, at least 1.8, at least 1.9) M and/or at most 2.0 (e.g., at most 1.9, at most 1.8, at most 1.7, at most 1.6, at most 1.5, at most 1.4, at most 1.3, at most 1.2, at most 1.1, at most 1.0, at most 0.9, at most 0.8, at most 0.7, at most 0.6) M of the acidic agent. In some embodiments, the leaching solution includes at least 2 (e.g., at least 3, at least 4, at least 5, at least 6, at least 7, at least 8, at least 9) vol. % and/or at most 10 (e.g., at most 9, at most 8, at most 7, at most 6, at most 5, at most 4, at most 3) vol. % of the reducing agent.

The acidic agent can include a mineral acid and/or an organic acid. Examples of mineral acids include sulfuric acid (H₂SO₄), hydrochloric acid (HCl), and phosphoric acid (H₃PO₄). Examples of organic acids include citric acid, tartaric acid, acetic acid, glycolic acid, maleic acid, succinic acid, acrylic acid, lactic acid, benzoic acid, and propionic acid. Examples of the reducing agent include hydrogen peroxide (H₂O₂), sodium bisulfite (NaHSO₃), ascorbic acid, and citric acid.

In certain embodiments, the leaching is performed at a pH of at least 0 (e.g., at least 0.5, at least 1, at least 1.5) and/or at most 2 (e.g., at most 1.5, at most 1, at most 0.5).

In certain embodiments, the dissolution is performed at a temperature of at least 60 (e.g., at least 61, at least 62, at least 63, at least 64, at least 65, at least 66, at least 67, at least 68, at least 69, at least 70, at least 71, at least 72, at least 73, at least 74, at least 75, at least 76, at least 77, at least 78, at least 79° C.) and/or at most 80 (e.g., at most 79, at most 78, at most 77, at most 76, at most 75, at most 74, at most 73, at most 72, at most 71, at most 70, at most 69, at most 68, at most 67, at most 66, at most 65, at most 64, at most 63, at most 62, at most 61° C.) In certain embodiments, the dissolution is performed for at least 1 (e.g., at least 2, at least 3, at least 4, at least 5) hour(s) and/or at most 6 (e.g., at most 5, at most 4, at most 3, at most 2) hours.

In some embodiments, the leaching efficiency of an element (Eᵢ) is calculated using the equation:

$${E}_{i} ( \% ) = \frac{{n}_{i} {M}_{cat}}{{m}_{cat} {χ}_{i}} \cdot 100 \%$$

where nᵢ is quantity (mol) of i element, M_{cat} is molar weight of the cathode (g/mol), m_{cat} is weight of the dissolved cathode powder (g), Xᵢ is molar fraction of the i element (from 0 to 1) obtained from the EDX analysis of the separated cathode active material powder.

In some embodiments, the leaching efficiency is at least 80 (e.g., at least 81, at least 82, at least 83, at least 84, at least 85, at least 86, at least 87, at least 88, at least 89, at least 90, at least 91, at least 92, at least 93, at least 94, at least 95, at least 96, at least 97) % and/or at most 98 (e.g., at most 97, at most 96, at most 95, at most 94, at most 93, at most 92, at most 91, at most 90, at most 89, at most 88, most 87, at most 86, at most 85, at most 84, at most 83, at most 82, at most 81) %. Without wishing to be bound by theory, it is believed that the leaching efficiency depends on the element (e.g., Ni, Co, Mn), the composition of the leaching solution, and the leaching conditions (e.g., temperature, time, pH). Without wishing to be bound by theory, it is believed that the leaching conditions can affect the leaching efficiency of an element significantly and often synergetically, which can make it non-trivial to distinguish their impacts without experimentation. Without wishing to be bound by theory, it is believed that increasing the temperature and/or the contact time can improve the leaching efficiency but can increase costs of the process in some cases. Without wishing to be bound by theory, it is believed that, in some embodiments, after a certain point the leaching efficiency cannot be enhanced further.

In step 1500, metal oxalates (having the empirical formula MC₂O₄, where M is a metal, such as, for example, nickel, manganese, and/or cobalt) are formed and precipitated. Without wishing to be bound by theory, it is believed that the metal oxalates precipitate upon formation. An aqueous solution of oxalic acid is reacted with the solution of dissolved cathode material obtained in step 1400. The reacting can be performed under gentle mixing and heating. The precipitated metal oxalates may then be centrifuged, washed, and dried. The metal oxalates correspond to the metals of the dissolved cathode material. For example, if the dissolved cathode material includes nickel, manganese, and/or cobalt, then the metal oxalates include nickel, manganese, and/or cobalt. In addition to or in alternative to oxalic acid, an oxalate salt (e.g., sodium oxalate, potassium oxalate, ammonium oxalate) can be used.

In certain embodiments, prior to the step 1500, the pH of the solution containing the dissolved cathode material is adjusted (e.g., increased) to a pH of at least 2 (e.g., at least 2.5, at least 3, at least 3.5, at least 4, at least 4.5, at least 5, at least 5.5, at least 6, at least 6.5) and/or at most 7 (e.g., at most 6.5, at most 6, at most 5.5, at most 5, at most 4.5, at most 4, at most 3.5, at least 3, at least 2.5). Without wishing to be bound by theory, it is believed that such a pH can increase (e.g., maximize) the efficiency (yield) of metal oxalate precipitation. In general, the pH can be adjusted (e.g., increased) using an alkaline solution, such as a solution of NaOH.

In some embodiments, the concentration of oxalic acid or oxalate salt (e.g., sodium oxalate, potassium oxalate, ammonium oxalate in the aqueous solution is at least 0.5 (e.g., at least 0.6, at least 0.7, at least 0.8, at least 0.9, at least 1.0, at least 1.1, at least 1.2, at least 1.3, at least 1.4, at least 1.5, at least 1.6, at least 1.7, at least 1.8, at least 1.9) M and/or at most 2 (e.g., at most 1.9, at most 1.8, at most 1.7, at most 1.6, at most 1.5, at most 1.4, at most 1.3, at most 1.2, at most 1.1, at most 1.0, at most 0.9, at most 0.8, at most 0.7, at most 0.6) M. In some embodiments, the oxalic acid is reacted with the dissolved cathode metals at a pH of at least 2 (e.g., at least 3, at least 4, at least 5) and/or at most 6 (e.g., at most 5, at most 4, at most 3).

In certain embodiments, the mixing and heating is performed at a temperature of at least 40 (e.g., at least 45, at least 50, at least 55) and/or at most 60 (e.g., at most 55, at most 50, at most 45° C.) In certain embodiments, the mixing and heating is performed for a duration of at least 0.1 (e.g., at least 0.2, at least 0.3, at least 0.4, at least 0.5, at least 0.6, at least 0.7, at least 0.8, at least 0.9) hours and/or at most 1 (e.g., at most 0.9, at most 0.8, at most 0.7, at most 0.6, at most 0.5, at most 0.4, at most 0.3, at most 0.2) hours.

In some embodiments, the metal oxalates can be obtained with a yield of at least 80 (e.g., at least 81, at least 82, at least 83, at least 84, at least 85, at least 86, at least 87, at least 88, at least 89, at least 90, at least 91, at least 92, at least 93, at least 94, at least 95, at least 96, at least 97, at least 98) % and/or at most 99 (e.g., at most 98, at most 97, at most 96, at most 95, at most 94, at most 93, at most 92, at most 91, at most 90, at most 89, at most 88, at most 87, at most 86, at most 85, at most 84, at most 83, at most 82, at most 81) %.

In step 1600, the metal oxalates formed in step 1500 are calcined to produce MONs. In certain embodiments, the calcination is performed at a temperature of at least 250 (e.g., at least 300, at least 350, at least 400° C.) and/or at most 450 (e.g., at most 400, at most 350, at most 300° C.) In certain embodiments, the calcination is performed for at least 1 (e.g., at least 2, at least 3) hour(s) and/or at most 4 (e.g., at most 3, at most 2) hours. In general, the calcination should be performed in an oxidative atmosphere. In certain embodiments, the calcination is performed in air. Without wishing to be bound by theory, it is believed that the metal oxalates undergo thermal decomposition to provide the MONs. In certain embodiments, no solvents (e.g., water) and/or additives are present during the calcination.

Without wishing to be bound by theory, it is believed that a specific temperature regime and timing during calcination can lead to desirable MONs. Without wishing to be bound by theory, it is believed that the size of the MONs is controllable. For example, it is believed that, in some embodiments, the size of the MONs can be varied by adjusting the metal oxalate precursor and/or the calcination conditions, including calcination temperature, calcination time, heating ramp rate and atmosphere. Adjusting the metal oxalate precursor can include varying the precipitating agent (the oxalate-anion source: oxalic acid, potassium oxalate, sodium oxalate, ammonium oxalate). Without wishing to be bound by theory, it is believed that the heating temperature affects the agglomeration of the nanoparticles and increasing the temperature, the heating ramp rate, and/or the heating time increases the size of the nanoparticles.

In some embodiments, the MONs have a size of at least 10 (e.g., at least 20, at least 30, at least 40, at least 50, at least 60, at least 70, at least 80, at least 90, at least 100, at least 200, at least 300, at least 400, at least 500, at least 600, at least 700, at least 800, at least 900, at least 1000, at least 2000, at least 3000, at least 4000, at least 5000, at least 6000, at least 7000, at least 8000, at least 9000) nm and/or at most 10000 (e.g., at most 9000, at most 8000, at most 7000, at most 6000, at most 5000, at most 4000, at most 3000, at most 2000, at most 1000, at most 900, at most 800, at most 700, at most 600, at most 500, at most 400, at most 300, at most 200, at most 100, at most 90, at most 80, at most 70, at most 60, at most 50, at most 40, at most 30, at most 20) nm.

In certain embodiments, the calcination temperature is at least 200 (e.g., at least 250, at least 300, at least 350, at least 400, at least 450° C.) and/or at most 500 (e.g., at most 450, at most 400, at most 350, at most 300, at most 250° C.) In certain embodiments, the calcination time is at least 0.5 (e.g., at least 1, at least 1.5, at least 2, at least 2.5, at least 3, at least 3.5, at least 4, at least 4.5, at least 5, at least 5.5) hours and/or at most 6 (e.g., at most 5.5, at most 5, at most 4.5, at most 4, at most 3.5, at most 3, at most 2.5, at most 2, at most 1.5, at most 1) hours. In certain embodiments, the heating ramp rate during the calcination is at least 1 (e.g., at least 2, at least 3, at least 4, at least 5, at least 6, at least 7, at least 8, at least 9° C.)/min and/or at most 10 (e.g., at most 9, at most 8, at most 7, at most 6, at most 5, at most 4, at most 3, at most 2° C.)/min.

Generally, the composition of the metal(s) present in the MONs is determined by the metal(s) present in the cathode material in the LIBs. For example, the MONs can include cobalt oxide, manganese oxide and/or nickel oxide provided that the cathode material includes cobalt, manganese and/or nickel. Alternatively or additionally, the cathode material can include aluminum, lithium, iron, and/or copper and the resulting MONs can include oxides of that metal.

In some embodiments, the MONs include at least 0 (e.g., at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) wt. % and/or at most 99 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5 at most 4, at most 3, at most 2, at most 1, at most 0.9, at most 0.8, at most 0.7, at most 0.6, at most 0.5, at most 0.4, at most 0.3, at most 0.2, at most 0.1) wt. % of cobalt oxide. In some embodiments, the MONs include at least 0 (e.g., at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) wt. % and/or at most 99 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5 at most 4, at most 3, at most 2, at most 1, at most 0.9, at most 0.8, at most 0.7, at most 0.6, at most 0.5, at most 0.4, at most 0.3, at most 0.2, at most 0.1) wt. % of nickel oxide. In some embodiments, the MONs include at least 0 (e.g., at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) wt. % and/or at most 99 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5 at most 4, at most 3, at most 2, at most 1, at most 0.9, at most 0.8, at most 0.7, at most 0.6, at most 0.5, at most 0.4, at most 0.3, at most 0.2, at most 0.1) wt. % of manganese oxide. In some embodiments, the MONs include at least 0 (e.g., at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) wt. % and/or at most 99 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5 at most 4, at most 3, at most 2, at most 1, at most 0.9, at most 0.8, at most 0.7, at most 0.6, at most 0.5, at most 0.4, at most 0.3, at most 0.2, at most 0.1) wt. % of aluminum oxide. In some embodiments, the MONs include at least 0 (e.g., at least 0.1, at least 0.2, at least 0.3, at least 0.4, at least 0.5, at least 0.6, at least 0.7, at least 0.8, at least 0.9) wt. % and/or at most 1 (e.g., at most 0.9, at most 0.8, at most 0.7, at most 0.6, at most 0.5, at most 0.4, at most 0.3, at most 0.2, at most 0.1) wt. % of lithium oxide. In some embodiments, the MONs include at least 0 wt. % and/or at most 0.001 wt. % of iron oxide. In some embodiments, the MONs include at least 0 wt. % and/or at most 0.001 wt. % of copper oxide.

In some embodiments, the MONs are magnetic. In some embodiments, the MONs are ferromagnetic. In some embodiments, the density of the MONs (e.g., as determined by gas pycnometry) is at least 2.5 (e.g., at least 3, at least 3.5, at least 4, at least 4.5, at least 5, at least 5.5, at least 6) g/cm³ and/or at most 6.5 (e.g., at most 6, at most 5.5, at most 5, at most 4.5, at most 4, at most 3.5, at most 3) g/cm³. In some embodiments, the surface area of the MONs (e.g., as determined by BET method with nitrogen adsorption) is at least 5 (e.g., at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, at least 100, at least 150, at least 200, at least 250) m²/g and/or at most 300 (e.g., at most 250, at most 200, at most 150, at most 100, at most 95, at most 90, at most 85, at most 80, at most 75, at most 70, at most 65, at most 60, at most 55, at most 50, at most 45, at most 40, at most 35, at most 30, at most 25, at most 20, at most 15, at most 10) m²/g.

Prior to the step 1500, in the step 1450, the oxalic acid or oxalate (e.g., alkali metal oxalate) used in the step 1500 is formed from carbon dioxide. In general, the oxalic acid or oxalate (e.g., alkali metal oxalate) can be prepared from carbon dioxide using any appropriate method. In some embodiments, oxalate (e.g., alkali metal oxalate) is produced directly from carbon dioxide by an electrochemical process catalyzed by a transition metal. In some embodiments, carbon dioxide is electrochemically converted into formate and subsequently converted into oxalic acid.

The carbon dioxide can be obtained by any appropriate method, such as by direct air capture, for example using a direct air capture or carbon dioxide capture unit based on adsorption.

In step 1600, the metal oxalates formed in step 1500 are calcined to form corresponding MONs. Without wishing to be bound by theory, it is believed that during the step 1600, the following reactions occur:

MC₂O₄→MOₓ+CO+CO₂

CO+1/2O₂→CO₂.

where M is a metal such as nickel, manganese, or cobalt. Without wishing to be bound by theory, it is believed that carbon dioxide produced during the thermal decomposition of the metal oxalates in the step 1600 can be captured and used in the step 1450. Thus, the method 1000 can be a closed loop process. Without wishing to be bound by theory, it is believed that capturing the carbon dioxide in the step 1600 for subsequent use in the step 1450 provides a relatively concentrated source of carbon dioxide, thereby reducing costs for carbon dioxide capture, decreasing the energy used to capture the carbon dioxide and reducing carbon dioxide emissions.

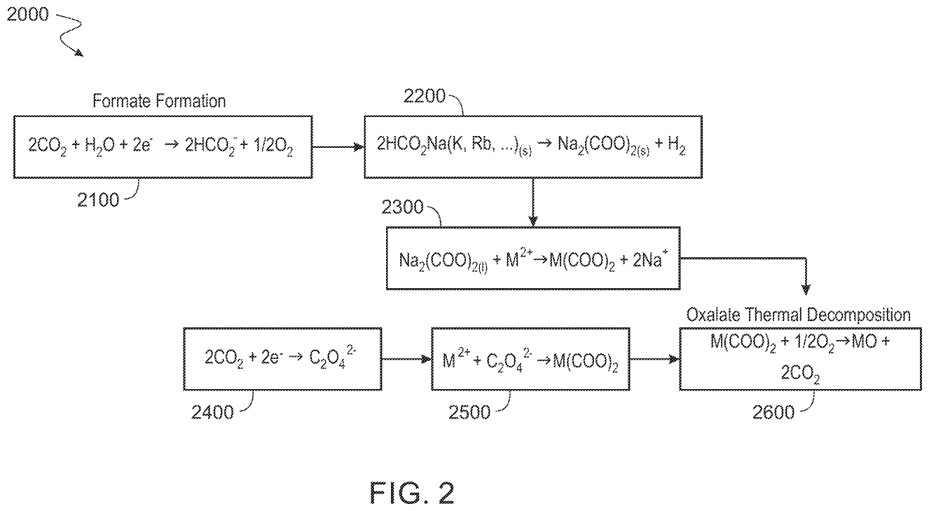

FIG. 2 depicts a flowchart for a method 2000 of forming MONs from carbon dioxide and metal obtained from the cathodes of LIBs. The steps shown in the method 2000 correspond to the steps 1450, 1500, and 1600 in the method 1000.

Steps 2100-2300 provide a route to form metal oxalates from carbon dioxide and the cathode material of LIBs via the formation of formate (e.g., an alkali-metal (Na, K, Cs, Rb, or Li) formate) as an intermediate. In step 2100, formate is formed by the electrochemical conversion of carbon dioxide. In step 2200, alkali-metal formate is crystallized (e.g., at 0° C. in a cold bath) then calcined in the presence of a catalyst (e.g., alkali hydroxides, pure metals, hydrides, amides, borohydrides, or other strong bases) to form alkali-metal oxalate. In some embodiments, the calcination in the step 2200 is performed at a temperature of at least 180 (e.g., at least 200, at least 220, at least 240, at least 260, at least 280, at least 300, at least 320, at least 340, at least 360, at least 380° C.) and/or at most 400 (e.g., at most 380, at most 360, at most 340, at most 320, at most 300, at most 280, at most 260, at most 240, at most 220, at most 200° C.) In step 2300, the alkali-metal oxalate is dissolved in deionized water and gently added into the solution of the dissolved metal ions obtained from the cathodes of LIBs to form and precipitate metal oxalate. In certain embodiments, in the step 2300, the alkali-metal oxalate is dissolved with a concentration of oxalate anions of at least 0.5 (e.g., at least 1, at least 1.5) M and/or at most 2 (e.g., at most 1.5, at most 1) M.

Steps 2400 and 2500 provide an alternative route to form metal oxalates from carbon dioxide and metal ions obtained after the dissolution of the cathodes of LIBs. In step 2400, oxalate is formed by the electrochemical conversion of carbon dioxide. In step 2500, the oxalates formed in the step 2400 are used to form metal oxalates with the metal ions obtained from the cathodes of LIBs.

In step 2600, the metal oxalates formed in the step 2300 and/or the step 2500 undergo thermal decomposition to form MONs. The step 2600 corresponds to the step 1600 in the method 1000.

To covert the alkali-metal oxalates into the acidic form (H₂C₂O₄, oxalic acid), addition of a strong mineral acid (e.g., HCl or H₂SO₄) or electrodialysis can be used.

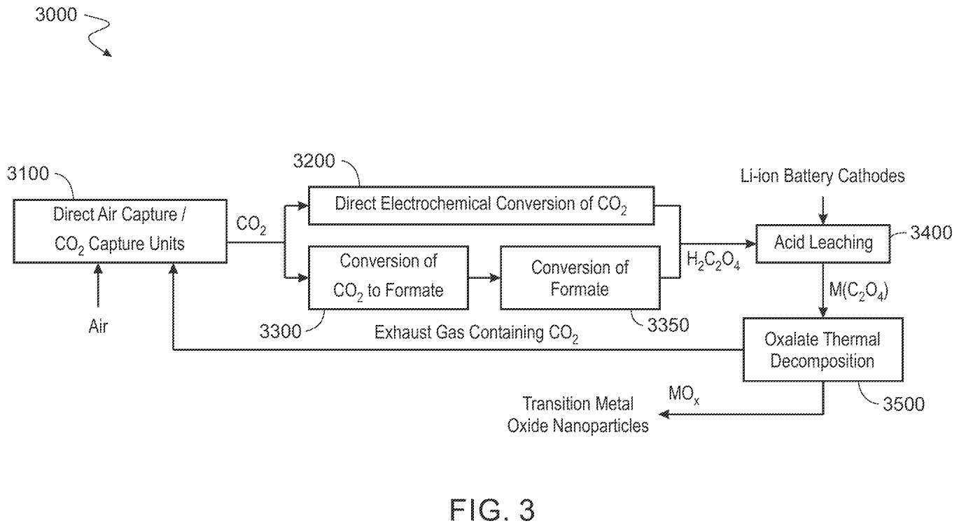

FIG. 3 depicts a flowchart for a method 3000 of converting carbon dioxide and the cathodes of LIBs into MONs.

In step 3100 carbon dioxide is captured from air using carbon dioxide capture units. In step 3200, the carbon dioxide obtained from the step 3100 undergoes direct electrochemical conversion to form oxalic acid. In step 3350, the formate produced in the step 3300 is converted to oxalic acid. In step 3400, metal is obtained from the cathodes of LIBs (corresponding to step 1400 in the method 1000, FIG. 1). The oxalic acid produced in the step(s) 3200 and/or 3300 and 3350 and the metal obtained from the step 3400 are combined to form a metal oxalate (corresponding to step 1500 in the method 1000, FIG. 1). In step 3500, the metal oxalates undergo thermal decomposition (calcination) to produce MONs (corresponding to step 1600 in the method 1000, FIG. 1). The step 3500 also produces an exhaust gas containing carbon dioxide. The carbon dioxide produced in the step 3500 can be captured in the step 3100 and used to produce additional oxalic acid in the method 3000.

In general, any appropriate method for the direct electrochemical conversion of carbon dioxide to oxalic acid can be used in the step 3200. Similarly, any appropriate method for the conversion of carbon dioxide to formate in the step 3300 and to form oxalic acid from formate in the step 3350 may be employed.

### Applications of Metal Oxide Nanoparticles

The MONs prepared by the methods of the disclosure can be used to improve the properties in drilling fluids, inks, and/or a fluid for enhanced oil recovery.

Without wishing to be bound by theory, it is believed that the MONs can enhance the rheological properties of drilling fluid due to the relatively high surface energies of the MONs and interactions with clay particles from the attachment of the MONs to edges of clay platelets and with positively charged ions present in the drilling fluid. However, an excessively high concentration of MONs may cause repulsion between the negatively charged MONs and other negatively charged additives in the drilling fluid, reducing (e.g., preventing) the aggregation of the clay particles and increasing the stability under high temperature and high pressure (HTHP) conditions. Without wishing to be bound by theory, it is believed that the use of the MONs in water-based drilling fluids can reduce filtration loss by to filling the micropores and nanopores in the filter cake.

Without wishing to be bound by theory, it is believed that due to certain desirable physicochemical properties of cobalt oxide and/or nickel oxide, metal nanoparticles that include cobalt oxide and/or nickel oxide can be incorporated into inks, such as inks for printed electronic applications (e.g., applications that include interactions with electromagnetic waves and/or high frequencies (ITU designation for the range of radio frequency electromagnetic waves (radio waves) between 3 and 30 megahertz (MHz))). Without wishing to be bound by theory, it is believed that generally, conducting ink is highly suitable for the fabrication of electrodes and it covers a broad range of applications in electronic devices, energy storage devices, solar panels, metamaterials, and antennas. The desirable physicochemical properties of cobalt oxide and/or nickel oxide include relatively high permeability, relatively high permittivity, and/or ability to withstand relatively high temperatures. Additionally, due to nickel's relatively high corrosion resistance, inks that include MONs with nickel can be used as a passivation layer to protect underlying printed patterns (e.g., printed with copper and silver nanoparticles inks) from oxidation and corrosion.

Without wishing to be bound by theory, it is believed that in flooding for enhanced oil recovery, MONs can improve fluid-rock interaction characteristics such as wettability and heat transfer coefficient. Additionally, without wishing to be bound by theory, it is believed certain fluid properties, such as density and viscosity of the displacing phase, interfacial tension, and oil viscosity may also be improved. Further, it is believed that the MONs are more stable than surfactants and polymers at higher temperatures and/or in saline environments.

### Non-Limiting Examples

Non-Limiting Example of Preparing Oxalic Acid from Carbon Dioxide

Directly captured CO₂ is electrochemically reduced to alkali-metal oxalate in a flow cell in 1 M KHCO₃ aqueous solution. The formed oxalate solution is transferred from the cell to a beaker, and the solution of dissolved cathode is added dropwise under intensive mixing. To covert the alkali-metal oxalates into the acidic form (H₂C₂O₄, oxalic acid), the same volume of 1 M H₂SO₄ can be added to the oxalate-containing solution.

### Non-Limiting Example of Preparing Metal Oxide Nanoparticles

Cell discharging is performed by immersing a LIB cell or a cell bundle into 10 wt. % NH₄HCO₃ solution for 12 hours. After the discharging, cell's voltage is suppressed from an average of 4.0 V to 1.0 V allowing safe dismantling.

The cell is disassembled after removal from the alkali solution. After removing the stainless-steel battery case and unwinding, the cathode, anode, and separator are immersed into 2 M alkali solution to neutralize F-containing salts in the LIB's liquid electrolyte. The cathode tape is washed with ethanol or isopropanol, dried for 12 hours, and cut into 2×2 cm² pieces.

16 g of the cut cathode is placed into a glass conic flask, and 80 mL of DMF, DMSO, or NMP is added to remove the polymeric binder and detach the cathode active material from the Al substrate. After mild mixing for 6 hours at 80° C., the detached black mass is filtered, washed with ethanol or isopropanol, and dried at 70° C. and 100 mBar for 12 hours. From one LIB cell, it is possible to obtain up to 16 g of cathode material from a cylindric cell of a form factor of 18650 (18 mm diameter and 65 mm length).

The dissolution of the cathode material is performed by using a leaching mixture with an acidic agent and a reducing agent. The leaching solution can include 1.0 M H₂SO₄+5 vol. % H₂O₂ or 1.0 M.

The dissolution is carried out under intensive stirring at 80° C. for 6 hours. After the dissolution, the carbon residue (3 wt. %) is filtered out. The leaching efficiency is 95% depending on the element (Ni, Co, Mn), leaching solution composition, and leaching conditions.

Metal oxalate formation and precipitation is performed by a gentle dropping of a 1.0 M aqueous solution of oxalic acid into the portion of solution with the dissolved cathode's metals at pH of 2. The precipitated mixture of Ni, Mn, and Co oxalates is centrifuged, washed, and dried.

The metal oxalates are calcinated at 400° C. for 2 hours in air to produce metal oxide particles with the controllable average size ranging from 10 nm to 10 μm.

### Embodiments

1. A method, including:
converting carbon dioxide into oxalic acid;
dissolving a cathode material including a metal using a leaching solution including an acidic agent and a reducing agent to provide a first solution including ions of the metal;
adding a second solution including a member selected from the group consisting of oxalic acid and an oxalate salt to the first solution to precipitate a metal oxalate; and
calcining the metal oxalate to form metal oxide nanoparticles.

2. The method of embodiment 1, further including:
prior to converting the carbon dioxide, capturing the carbon dioxide from a source; and using the captured carbon dioxide in the conversion of carbon dioxide into oxalic acid.

3. The method of embodiment 2, wherein calcining the metal oxalate produces carbon dioxide, and the carbon dioxide produced by calcining the metal oxalate is captured.

4. The method of any one of embodiments 1-3, wherein converting the carbon dioxide into oxalic acid includes direct electrochemical conversion of carbon dioxide into oxalic acid.

5. The method of any one of embodiments 1-4, wherein converting the carbon dioxide into oxalic acid includes:
converting carbon dioxide into formate; and converting the formate into oxalic acid.

6. The method of any one of embodiments 1-5, wherein the leaching solution includes from 0.5 M to 2 M of the acidic agent and from 2 vol. % to 10 vol. % of the reducing agent.

7. The method of any one of embodiments 1-6, wherein:
the acidic agent includes a member selected from the group consisting of sulfuric acid, citric acid, tartaric acid, acetic acid, glycolic acid, maleic acid, succinic acid, acrylic acid, lactic acid, benzoic acid, and propionic acid; and
the reducing agent includes a member selected from the group consisting of hydrogen peroxide, sodium bisulfite, ascorbic acid, and citric acid.

8 The method of any one of embodiments 1-7, wherein dissolving the cathode material is performed at a temperature of from 60° C. to 80° C.

9. The method of any one of embodiments 1-8, wherein the calcining is performed at a temperature of from 250° C. to 450° C.

10. The method of any one of embodiments 1-9, wherein the calcining is performed for from 1 hour to 4 hours.

11. The method of any one of embodiments 1-10, wherein the metal oxide nanoparticles include at least one member selected from the group consisting of nickel oxide, manganese oxide and cobalt oxide.

12. The method of embodiment 11, wherein the metal oxide nanoparticles include:
from 0 to 99 wt. % nickel oxide;
from 0 to 99 wt. % manganese oxide; and from 0 to 99 wt. % cobalt oxide.

13. The method of any one of embodiments 1-12, wherein the metal oxide nanoparticles have a size of 10 nm to 10000 nm.

14. The method of any one of embodiments 1-13, further including, prior to adding the second solution, adjusting a pH of the first solution to from 2 to 7.

15. The method of any one of embodiments 1-14, further including, prior to dissolving the cathode material, isolating the cathode material from at least one other component of a lithium-ion battery, including contacting the cathode material with a solvent.

16. The method of embodiment 15, wherein contacting the cathode material with a solvent is performed at a temperature of from 65° C. to 90° C.

17. The method of embodiment 15 or 16, further including, prior to isolating the cathode material from at least one other component of a lithium-ion battery, dismantling a lithium-ion battery cell or bundle.

18. The method of embodiment 17, further including, prior to dismantling the lithium-ion battery cell or bundle, discharging the lithium-ion battery cell or bundle, including immersing the lithium-ion battery cell or bundle in an alkali solution.

19. The method of embodiment 18, wherein the alkali solution has a concentration of an alkali agent of 5 wt. % to 15 wt. %. 20. The method of any one of embodiments 1-19, further including, forming a member selected from the group consisting of a drilling fluid, an ink and a fluid used in an enhanced oil recovery operation, wherein the member includes the metal oxide nanoparticles.

What is claimed:

1. A method, comprising:
converting carbon dioxide into oxalic acid;
dissolving a cathode material comprising a metal using a leaching solution comprising an acidic agent and a reducing agent to provide a first solution comprising ions of the metal;
adding a second solution comprising a member selected from the group consisting of oxalic acid and an oxalate salt to the first solution to precipitate a metal oxalate; and
calcining the metal oxalate to form metal oxide nanoparticles.

2. The method of claim 1, further comprising:
prior to converting the carbon dioxide, capturing the carbon dioxide from a source; and
using the captured carbon dioxide in the conversion of carbon dioxide into oxalic acid.

3. The method of claim 2, wherein calcining the metal oxalate produces carbon dioxide, and the carbon dioxide produced by calcining the metal oxalate is captured.

4. The method of claim 1, wherein converting the carbon dioxide into oxalic acid comprises direct electrochemical conversion of carbon dioxide into oxalic acid.

5. The method of claim 1, wherein converting the carbon dioxide into oxalic acid comprises:
converting carbon dioxide into formate; and
converting the formate into oxalic acid.

6. The method of claim 1, wherein the leaching solution comprises from 0.5 M to 2 M of the acidic agent and from 2 vol. % to 10 vol. % of the reducing agent.

7. The method of claim 1, wherein:
the acidic agent comprises a member selected from the group consisting of sulfuric acid, citric acid, tartaric acid, acetic acid, glycolic acid, maleic acid, succinic acid, acrylic acid, lactic acid, benzoic acid, and propionic acid; and
the reducing agent comprises a member selected from the group consisting of hydrogen peroxide, sodium bisulfite, ascorbic acid, and citric acid.

8. The method of claim 1, wherein dissolving the cathode material is performed at a temperature of from 60° C. to 80° C.

9. The method of claim 1, wherein the calcining is performed at a temperature of from 250° C. to 450° C.

10. The method of claim 1, wherein the calcining is performed for from 1 hour to 4 hours.

11. The method of claim 1, wherein the metal oxide nanoparticles comprise at least one member selected from the group consisting of nickel oxide, manganese oxide and cobalt oxide.

12. The method of claim 11, wherein the metal oxide nanoparticles comprise:
from 0 to 99 wt. % nickel oxide;
from 0 to 99 wt. % manganese oxide; and
from 0 to 99 wt. % cobalt oxide.

13. The method of claim 1, wherein the metal oxide nanoparticles have a size of from 10 nm to 10000 nm.

14. The method of claim 1, further comprising, prior to adding the second solution, adjusting a pH of the first solution to from 2 to 7.

15. The method of claim 1, further comprising, prior to dissolving the cathode material, isolating the cathode material from at least one other component of a lithium-ion battery, comprising contacting the cathode material with a solvent.

16. The method of claim 15, wherein contacting the cathode material with a solvent is performed at a temperature of from 65° C. to 90° C.

17. The method of claim 15, further comprising, prior to isolating the cathode material from at least one other component of a lithium-ion battery, dismantling a lithium-ion battery cell or bundle.

18. The method of claim 17, further comprising, prior to dismantling the lithium-ion battery cell or bundle, discharging the lithium-ion battery cell or bundle, comprising immersing the lithium-ion battery cell or bundle in an alkali solution.

19. The method of claim 18, wherein the alkali solution has a concentration of an alkali agent of 5 wt. % to 15 wt. %.

20. The method of claim 1, further comprising, forming a member selected from the group consisting of a drilling fluid, an ink and a fluid used in an enhanced oil recovery operation, wherein the member comprises the metal oxide nanoparticles.
